(19) United States
(12) Patent Application Publication
(10) Pub. No.: US 2024/0362478 A1
(43) Pub. Date: Oct. 31, 2024

(54) CERTIFIABLE OUT-OF-DISTRIBUTION GENERALIZATION METHOD, MEDIUM, AND ELECTRONIC DEVICE

(71) Applicant: Shanghai ArtificialIntelligence Innovation Center, Shanghai (CN)

(72) Inventors: Nanyang YE, Shanghai (CN); Qinying GU, Shanghai (CN); Lin ZHU, Shanghai (CN); Zhaoyu ZENG, Shanghai (CN); Jiayao SHAO, Shanghai (CN); Chensheng PENG, Shanghai (CN); Bikang PAN, Shanghai (CN); Kaican LI, Shanghai (CN); Jun ZHU, Shanghai (CN); Xinbing WANG, Shanghai (CN); Chenghu ZHOU, Shanghai (CN)

(73) Assignee: Shanghai ArtificialIntelligence Innovation Center, Shanghai (CN)

(21) Appl. No.: 18/597,857

(22) Filed: Mar. 6, 2024

(30) Foreign Application Priority Data
Apr. 25, 2023 (CN) 2023104556449

(51) Int. Cl. G06N 3/08

(52) U.S. Cl. CPC G06N 3/08

(57) ABSTRACT

The present application discloses a certifiable out-of-distribution generalization method, a medium, and an electronic device. The method comprises: approximating a deep neural network model using kernelized linear regression; subjecting the deep neural network model to stochastic perturbation learning to derive a classifier for sample separation; and determining a generalization set and certified precision of the deep neural network model, wherein the deep neural network model can output accurate predictions when the perturbation range of semantic information lies within the generalization set, the semantic information being defined as the representation of cascaded intermediate layers of the deep neural network model.

### CROSS-REFERENCE TO RELATED APPLICATIONS

The application claims priority to Chinese patent application No. 2023104556449, filed on Apr. 25, 2023, the entire contents of which are incorporated herein by reference.

### TECHNICAL FIELD

The present application relates to the technical field of artificial intelligence, and in particular to a certifiable out-of-distribution generalization method, a medium, and an electronic device.

### BACKGROUND

Deep learning models have been applied in various fields, including computer vision and natural language processing. However, traditional algorithms excel only with independent and identically distributed datasets, outperforming human performance. Yet, model performance significantly drops when encountering out-of-distribution (OoD) data. This limitation hinders the widespread application of deep learning, particularly in high-risk fields like healthcare, autonomous driving, and finance. In these fields, distribution variations between training data and test data are ubiquitous, leading to severe consequences from machine learning's erroneous predictions. Existing methods fail to achieve ideal performance across different types of distribution shifted datasets. Furthermore, without theoretical guarantees, it remains unclear how existing methods perform on or to what extent they are applicable to any given OoD data.

Currently, some methods have been proposed to mitigate the degradation in model performance for OoD data that share the same distribution as the test data and the training data. However, due to the complexity of OoD generalization, models need to generalize across various unseen domains. Existing methods struggle to simultaneously achieve better performance across different types of distribution shifts than the Empirical Risk Minimization (ERM) method.

In general, to alleviate the aforementioned issues, researchers suggest employing larger datasets and models with a significant number of parameters. However, collecting and using big data often incurs significant costs and resources and may not be widely applicable to real-world scenarios. In addition, some researchers have proposed OoD generalization algorithms. However, these methods typically exhibit preferences towards one type of distribution shift and do not effectively deal with another type of distribution shift.

OoD generalization is a task that involves generalizing model performance under distribution variations between training and testing, contrasting sharply with adversarial defenses, which aim to have robust classifiers to prevent adding subtle perturbations to images, the perturbations being akin to noise in images. OoD generalization focuses on categorizing data with similar semantic information but varying environmental or stylistic information, a situation more common in real-world scenarios than deliberate adversarial attacks. For example, models must generalize to unseen environments to ensure the safety of autonomous driving. Existing OoD generalization algorithms typically fall into four types: domain generalization-based methods, focusing on learning consistent patterns from data collected in diverse environments; invariant learning-based methods, excluding spurious correlations present in the data; distributionally robust optimization methods, constructing challenging data distributions based on original data; and causal learning-based methods using causal inference techniques. These methods have empirically demonstrated improvements in OoD generalization tasks, yet their theoretical performance in OoD generalization remains largely underdeveloped.

Studies have revealed multiple dimensions in OoD generalization datasets, whereas existing algorithms often outperform ERM in one dimension but underperform in another dimension. These dimensions can be described as diversity shift or correlation shift. Diversity shift is formally defined as the difference in the environmental semantic feature's training and testing probability density functions (p.d.f.s) on the overall differences between two distributions' supports. In comparison, correlation shift is defined as the difference in environmental semantic features' marginal p.d.f.s at the intersection of the training and testing distributions. Currently, few methods can achieve better performance than ERM concurrently on both types of OOD shifts.

Furthermore, existing theories often require assumptions and optimizations under constrained conditions. One of the most promising directions is Distributionally Robust Optimization (DRO) within robust optimization frameworks. The theory behind DRO revolves around minimizing the worst-case risk of an uncertain distribution set centered around the training distribution. In this scenario, reasonable distance measures (e.g., f-Divergence, Wasserstein distance, MMD) can be freely chosen to define uncertainty sets, addressing OoD generalization from various perspectives. Gao and Kleywegt proposed in 2016 that the bounds of worst-case risk are obtained under the minimum assumption that the loss function is bounded for any black-box machine learning function. Another research direction is invariance-based optimization, which defines an information theory-based optimization problem where the Shannon mutual information between two stochastic variables is optimized under invariant sets.

In conclusion, researchers typically employ larger datasets and models with a significant number of parameters for OoD generalization, yet existing solutions have not addressed the fundamental issue of OoD data generalization. For example, despite the autonomous driving industry pouring billions into data collection, achieving robust object detection in autonomous vehicles remains challenging. Furthermore, in large-scale natural language processing models like GPT-3, peculiar prompts are required to produce correct answers. For example, posing the question “The capital of Belgium is” to the model would yield the response “A nice city”; however, only when adding the prefix “The capital of France is Paris” does the model provide the correct answer. In summary, the limitations of existing OoD algorithms lie in the fact that model prediction results are effective only under minor distribution variations, and the derived bounds cannot be numerically computed. Moreover, enforcing strong assumptions on the loss function or machine learning model is sometimes necessary to ensure effectiveness. These limitations make it challenging for these models to be applied to real-world data, where distribution variations are typically substantial.

### SUMMARY

The objective of the present application is to overcome the defects in the prior art by providing a certifiable OoD generalization method, a medium, and an electronic device.

According to a first aspect of the present application, a certifiable OoD generalization method is provided. The method comprises:
approximating a deep neural network model using kernelized linear regression;
subjecting the deep neural network model to stochastic perturbation learning to derive a classifier for sample separation; and
determining a generalization set of the deep neural network model, wherein the deep neural network model can output accurate predictions when a perturbation range of semantic information lies within the generalization set, the semantic information being defined as a representation outputted by cascaded intermediate layers of the deep neural network model.

According to a second aspect of the present application, a non-transitory computer-readable storage medium having a computer program stored thereon is provided, wherein the computer program, when run by a processor, implements the following steps:
approximating a deep neural network model using kernelized linear regression;
subjecting the deep neural network model to stochastic perturbation learning to derive a classifier for sample separation; and
determining a generalization set of the deep neural network model, wherein the deep neural network model can output accurate predictions when a perturbation range of semantic information lies within the generalization set, the semantic information being defined as a representation of cascaded intermediate layers of the deep neural network model.

According to a third aspect of the present application, an electronic device is provided, comprising a memory and a processor, wherein a computer program capable of running on the processor is stored on the memory, and the processor runs the computer program to implement the following steps:
approximating a deep neural network model using kernelized linear regression;
subjecting the deep neural network model to stochastic perturbation learning to derive a classifier for sample separation; and
determining a generalization set of the deep neural network model, wherein the deep neural network model can output accurate predictions when a perturbation range of semantic information lies within the generalization set, the semantic information being defined as a representation of cascaded intermediate layers of the deep neural network model.

Compared with the prior art, the advantages of the present application lie in proposing a certifiable method for distribution shifts in OoD generalization. The method utilizes an optimization framework based on stochastic distributions and maximum margin learning of each input data to provide guarantees for OD generalization performance. The present application can provide validated prediction precision for every input data in the semantic space and can achieve improved performance on OoD datasets dominated by correlation shifts or diversity shifts, or a combination of both.

Through a detailed description of exemplary embodiments of the present application with reference to the accompanying drawings, additional features and advantages of the present application will become apparent.

### BRIEF DESCRIPTION OF DRAWINGS

The accompanying drawings, which are incorporated in and constitute a part of the specification, illustrate the embodiments of the present application and, together with the description, serve to explain the principles of the present application.

FIG. 1 is a flowchart of a certifiable out-of-distribution (OoD) generalization method according to an embodiment of the present application;

FIG. 2 illustrates an example of certifiable OoD data according to an embodiment of the present application;

FIG. 3 is a schematic diagram of certified accuracy and ablation study results according to an embodiment of the present application;

FIG. 4 is a visualization of samples with certifiable predictions according to an embodiment of the present application; and

FIG. 5 is a schematic diagram of the physical structure of an electronic device according to an embodiment of the present application.

### DETAILED DESCRIPTION OF THE EMBODIMENTS

Various exemplary embodiments of the present application will now be described in detail with reference to the accompanying drawings. It should be noted that the relative arrangement of the components and steps, the numerical expressions, and the numerical values set forth in the embodiments do not limit the scope of the present application unless it is specifically stated otherwise.

The following description of at least one exemplary embodiment is merely illustrative in nature and is in no way intended to limit the present application, application thereof, or use thereof.

Techniques, methods, and devices known to those of ordinary skills in the relevant art may not be discussed in detail, but the techniques, methods, and devices should be considered as a part of the specification where appropriate.

In all examples shown and discussed herein, any specific value should be construed as exemplary only rather than limiting. Thus, other examples of the exemplary embodiments may have different values.

It should be noted that: similar reference numbers and letters refer to similar items in the following figures, and thus, once an item is defined in one figure, it does not need to be further discussed in subsequent figures.

Hereinafter, a method for providing mathematically certifiable proof for predictions made on each input data will be firstly introduced. Based on theoretical results, a maximum margin training method is proposed and analyzed using the neural tangent kernel theory to improve the certification boundary. Lastly, examples of a practical certifiable OOD generalization algorithm are presented.

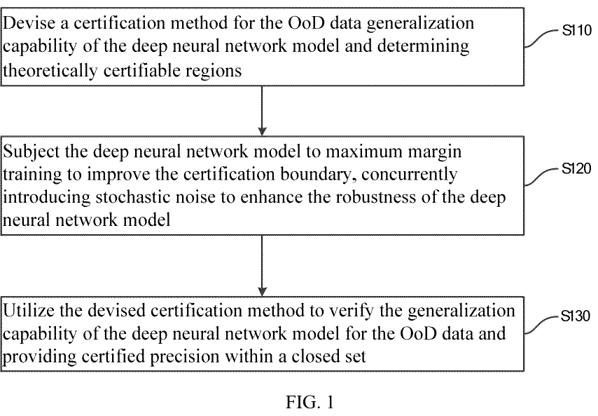

Referring to FIG. 1, the provided certifiable OOD generalization method comprises the following steps:

Step S110 involves devising a certification method for the OoD data generalization capability of the deep neural network model and determining theoretically certifiable regions.

For example, (X, Y) is used to represent a dataset comprising n data pairs, where X∈ [symbol] , Y∈ [symbol] . f_{θ}(⋅)=f(⋅; θ)=f_{L-1}∘f_{L-2} . . . ∘f₀ is used as an L-layer deep neural network (DNN) with the final layer serving as the classification layer, where θ∈ [symbol] represents the parameters of the DNN. Throughout the subsequent discussion, f(⋅) will be used as a shorthand for this deep neural network.

It should be noted that the neural network may be applied to various scenarios such as image detection, semantic segmentation, etc., where the output of the neural network can be binary or multi-class classification, etc. Moreover, depending on the application, datasets can have different distributions (like Gaussian distributions) or types (discrete or continuous). For example, in image object detection, each data pair in the aforementioned dataset could represent a correlation between image data and corresponding class labels (e.g., vehicles, pedestrians, etc.).

In one embodiment, to simplify the process without compromising generalizability, a 0-1 classification problem is considered, where the output range of f is [0,1]. Studies have indicated that the intermediate representations (IR) z learned by the DNN exhibit semantic features of the objects to be recognized. Given input data x, the semantic representation is defined as the representation of cascaded intermediate layers: z=[f₀(x), f₁(x), . . . , f_{L-2}(x)]. To maintain generalizability, it is necessary to prove that if f(z)>½, then for a surrounding set [symbol] of z, it still holds true, meaning that for any changes in semantic information δ, as long as δ∈ [symbol] , then f(z⊗δ)≥½, where ⊗ represents either addition or multiplication operators. Formally, the following is used for [symbol] -Generalizable definition in OoD generalization.

Definition 1: As for the aforementioned 0-1 classification problem for [symbol] -Generalizable, where f(z)∈[0,1], given [symbol] is a closed set and f(z)>½, it is defined that if for any perturbation δ within set [symbol] , the function f at z is [symbol] -Generalizable, namely, δ∈ [symbol] , f(z⊗δ)>½.

Remark 1: For convenience, it will be abbreviated as f(z) is [symbol] -Generalizable. It should be understood that while discussing the example of a [0,1] classification problem, this can also be extended to multi-class cases. Next, certifiable methods will be introduced to derive the [symbol] -Generalizable model and the corresponding generalizable set [symbol] .

Hereinafter, the stochastic perturbation version of this model will be introduced. Assuming π₀ represents the distribution of stochastic perturbations, the stochastic model is defined as the average predictive expectation over the semantic representation distribution:

$${f}_{{π}_{0}} ( z ) : = {η ∼ {π}_{0}}_{} [ f ( z ⊗ η ) ] \qquad ( 1 )$$

We aim to prove that if the original classifier can still provide an accurate prediction under stochastic perturbations (f_{π}_{₀}(z)>½), then the following inequality holds for any perturbation within a certain range δ∈ [symbol] :

$$\begin{matrix}{min}_{δ ∈} {f}_{{π}_{0}} ( z ⊗ δ ) = {min}_{δ ∈} {f}_{{π}_{δ}} ( z ) \\ = {min}_{δ ∈} {η ∼ {π}_{0}}_{} [ f ( z ⊗ η ⊗ δ ) ] > 1 / 2\end{matrix} \qquad ( 2 )$$

where ⊗ represents element-wise addition or element-wise multiplication, π_{δ} represents the distribution of η⊗δ. To derive an easily computable lower bound for

$${min}_{δ ∈} {f}_{{π}_{0}} ( z ⊗ δ ) ,$$

f is further relaxed to a functional space [symbol] ={\hat{f}: \hat{f}(z)∈[0,1], ∀z∈ [symbol] }, i.e. the set of all functions bounded by [0,1], with the equality constraints at the original function f:

$${min}_{δ ∈} {f}_{{π}_{0}} ( z ⊗ δ ) \geq {min}_{\hat{f} ∈} \{ {min}_{δ ∈} {\hat{f}}_{{π}_{0}} ( z ⊗ δ ) \} \\ s . t . {\hat{f}}_{{π}_{0}} ( z ) = {f}_{{π}_{0}} ( z ) \qquad ( 3 )$$

Remark 2: To make the lower bound computable, due to f being a typically challenging high-dimensional nonlinear function (deep neural network), it is further relaxed to any function within the [0,1] range, with an additional constraint that it should provide the same predictions as the original function. Note that the aforementioned inequality can be solved using the Lagrange method.

Theorem 1 (Lagrange): Using π_{δ} to represent the distribution of η⊗δ, solving inequality (3) is equivalent to solving the following problem:

$$ℒ = {min}_{\hat{f} ∈} {min}_{δ ∈} {max}_{λ ∈} \{ \hat{{f}_{{π}_{0}}} ( z ⊗ δ ) - λ ( {\hat{f}}_{{π}_{0}} ( z ) - {f}_{{π}_{0}} ( z ) ) \} \geq {max}_{λ \geq 0} \{ λ {f}_{{π}_{0}} ( z ) - {max}_{δ ∈} ( {λπ}_{0} , {π}_{δ} ) \} \qquad ( 4 )$$

where [symbol] (λπ₀, π_{δ}) is as follows:

$$\begin{matrix}( {λπ}_{0} , {π}_{δ} ) = {max}_{\hat{f} ∈} \{ λ {η ∼ {π}_{0}}_{} [ \hat{f} ( z ⊗ η ) ] - {η ∼ {π}_{δ}}_{} [ \hat{f} ( z ⊗ η ) ] \} \\ = \{ \begin{matrix}\int {[ {λπ}_{0} ( η ) - {π}_{δ} ( η ) ]}_{+} d η , & if π is continuous , \\ \sum {[ {λπ}_{0} ( η ) - {π}_{δ} ( η ) ]}_{+} , & if π is discrete .\end{matrix}\end{matrix} \qquad ( 5 )$$

Remark 3: This theorem does not rely on the (local) additional convexity assumption of the deep neural network, which is network architecture-agnostic, meaning that the derived bounds can be applied to any black-box model. According to this result, the OoD generalizable set [symbol] can be derived by solving [symbol] >½. Based on Theorem 1, there are propositions and explanations for various perturbation distributions.

Proposition 1 (Gaussian Distribution): In the case where data follows a Gaussian distribution, instantiating π₀ as a Gaussian distribution centered at 0: [symbol] (0, σ²I), with ⊗ as the addition operator, and f_{π}_{₀}(z)>½. Then f_{π}_{₀}(z) is [symbol] -Generalizable for [symbol] ={δ:∥δ∥₂≤r}, where the perturbation range r satisfies the lower bound of prediction confidence:

$$ℒ \geq Φ ( {Φ}^{- 1} ( {f}_{{π}_{0}} ( z ) ) - \frac{r}{σ} ) > \frac{1}{2} \qquad ( 6 )$$

where Φ(⋅) represents the cumulative density function of the standard Gaussian distribution, which provides:

$$r < {σΦ}^{- 1} ( {f}_{{π}_{0}} ( z ) ) \qquad ( 7 )$$

Thus, when the perturbation range r lies within the generalizable set [symbol] , the stochastic classifier consistently provides accurate predictions.

Furthermore, the Bernoulli distribution is also considered, which can provide discrete stochastic perturbations to semantic representations. The Bernoulli distribution is a widely used dropout method to alleviate overfitting in the deep neural network. Our results concurrently explain why dropout works.

Proposition 2 (Bernoulli Distribution): In this scenario, instantiating π₀ as a Bernoulli distribution with probabilities set to zero, namely p∈[0,1). ⊗^{⊗} represents the multiplication operator, and

$${f}_{{π}_{0}} ( z ) > \frac{1}{2} \cdot {‖ \cdot ‖}_{0}$$

represents the l0-norm, which computes the number of non-zero elements in a vector. Then, f_{π0}(z) is [symbol] -Generalizable for [symbol] ={δ:∥δ−1∥₀≤r}, where r satisfies the lower bound of prediction confidence:

$$ℒ \geq max \{ {f}_{{π}_{0}} ( z ) - 1 + {p}^{r} , 0 \} > \frac{1}{2} \qquad ( 8 )$$

where:

$$r < \frac{ln ( 1.5 - {f}_{{π}_{0}} ( z ) )}{ln p} \qquad ( 9 )$$

According to Proposition 2, the radius of the generalizable set [symbol] is the reciprocal of ln(p). This offers a reasonable theoretical explanation as to why the widely used dropout method can assist in avoiding overfitting and enhancing generalization performance. It further reveals an inherent trade-off between selecting a higher dropout rate p and maintaining

$${f}_{{π}_{0}} ( z ) > \frac{1}{2} .$$

Furthermore, this analysis points towards a new research direction by automatically searching for optimal parameters of stochastic distribution.

Remark 4: The above analysis provides a method to demonstrate OoD generalization algorithms. Although the above analysis is based on a 0-1 classification problem, it can be directly extended to a multi-class classification problem by constructing multiple one-vs-one classification problems. The prerequisite for the propositions to hold is

$${f}_{{π}_{0}} ( z ) > \frac{1}{2} .$$

Furthermore, in the binary classification setting, as f_{π}_{₀}(z) approaches 1 (i.e., moves farther from the decision boundary), the permissible perturbation range r (i.e., the certifiable region [symbol] ) derived from formula (7) grows larger.

Step S120 involves subjecting the deep neural network model to maximum margin training to improve the certification boundary, concurrently introducing stochastic noise to enhance the robustness of the deep neural network model.

In one embodiment, to find a certifiable region as large as possible, maximum margin training (i.e., max-margin training) is introduced, which aligns with the strategy of distancing from the decision boundary. The task of maximum margin training is to identify the optimal hyperplane that linearly separates two separable classes. To ensure robustness, the optimal hyperplane is generally defined as a hyperplane that maximizes its distance to the closest points of the two separable data clouds (i.e., =½ margin). According to the Neural Tangent Kernel (NTK) theory, when the network dimension approaches infinity, kernelized linear regression can be used to approximate a high-dimensional nonlinear deep neural network model f_{π}_{₀}(x; θ):

$${f}_{{π}_{0}} ( x ; θ ) \approx {f}_{{π}_{0}} ( x ; w ) \approx {f}_{{π}_{0}} ( x ; {w}_{0} ) + {Ψ}_{{π}_{0}} ( x ; {w}_{0} ) ( w - {w}_{0} ) \qquad ( 10 )$$

where Ψ_{π}_{₀}(x; w₀) represents the Neural Tangent Kernel (NTK), w represents the parameters of the last layer, and w0 represents the initialization of the last layer. Subsequently, a maximum margin linear classifier for separating samples is derived.

Theorem 2 (Maximum Margin Classifier): If allowing for outliers (points within the margin or even on the other side of the decision boundary), the parameters of the Neural Tangent Kernel Maximum Margin (NTK max-margin) classifier satisfy the following optimality condition:

$${min}_{ξ , w} \frac{1}{2} {‖ w ‖}^{2} + C {\sum }_{i = 1}^{n} {ξ}_{i} \\ s . t . {y}_{i} ( {f}_{{π}_{0}} ( {x}_{i} ; {w}_{0} ) + {Ψ}_{{π}_{0}} ( {x}_{i} ; {w}_{0} ) ( w - {w}_{0} ) ) \geq 1 - {ξ}_{i} , {ξ}_{i} \geq 0 , i = 1 , ⋯ , n \qquad ( 11 )$$

where ξᵢ/∥w∥ represents the distance along the i-th from the farthest outlier to the decision boundary (margin), and C represents a hyperparameter controlling the cost of outliers. This is equivalent to solving the following optimization problem:

$${min}_{w} \frac{1}{2} {‖ w ‖}^{2} + C {\sum }_{i = 1}^{n} max ( 0 , \underbrace{1 - {y}_{i} ( {f}_{{π}_{0}} ( {x}_{i} ; {w}_{0} ) + {Ψ}_{{π}_{0}} ( {x}_{i} ; {w}_{0} ) ( w - {w}_{0} ) )}_{Training loss} ) \qquad ( 12 )$$

From the above formula, it is evident that the essence of the max-margin classifier involves introducing the Hinge loss, which simply ensures that the training loss is greater than a constant. In practice, this can also be achieved by selecting samples to generate larger losses in a batch of training to avoid introducing additional task-related hyperparameters for practical reasons.

Step S130 involves utilizing the devised certification method to verify the generalization capability of the deep neural network model for the OoD data and providing certified precision within a closed set.

Based on steps S110 and S120, the generalization capability of the neural network model for the OoD data can be evaluated. For example, the application process comprises: approximating a deep neural network model using kernelized linear regression; subjecting the deep neural network model to stochastic perturbation learning to derive a classifier for sample separation; and determining a generalization set and certification precision of the deep neural network model.

Specifically, based on the above theoretical analysis, an instance of the algorithm is further proposed, which involves stochastic perturbation learning using the example of Gaussian distribution. For Gaussian distribution, the expected stochastic perturbation loss for the data pair (Xi, Yi) is expressed as:

$${{π}_{0}}_{} [ ℓ ( f ( {X}^{i} ; θ ) , {Y}^{i} ) ] = {( 0 , {σ}^{2} )}_{} [ ℓ ( {f}_{L - 1} ( ( z + η ) ; θ ) , {Y}^{i} ) ] \qquad ( 13 )$$

where z=f_{L-2} ∘ . . . ∘f₀(Xⁱ; θ), σ represents the variance of the added Gaussian distribution, and [symbol] represents the loss function.

The practical application process comprises: training the deep neural network model with stochastic perturbation learning, such as the expected stochastic perturbation loss expressed in formula (13); and providing certified precision within the closed set [symbol] according to the propositions from step S110. This certification method can provide theoretical performance guarantees for the application of the neural network model in high-risk scenarios.

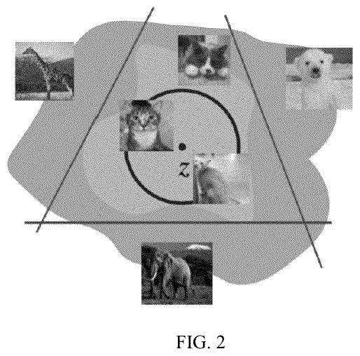

FIG. 2 illustrates an example of certifiable OoD data, where the black central point represents live input data in the semantic space, which is categorized as a cat. The black circle represents the certifiable range within which the present application classifies data as a cat with theoretical guarantees. The lighter area outside the black circle represents a semantic space where input samples are also categorized as cats but without guarantees. The darker area beyond the lighter area represents a semantic space where input samples are classified as other types, such as bears, elephants, and giraffes. Three straight lines represent the decision boundaries of the model, which are formed by the proposed maximum margin training method to separate different classes.

To further verify the effectiveness of the present application, empirical experiments were conducted. Considering that benchmarking results on OoD datasets are often influenced by hyperparameter selection, fair comparisons were made by using the OoDBenchsuit implemented based on DomainBed to evaluate the effectiveness of the present application. With the aid of OoD-Benchsuit, it was possible to evaluate OD generalization performance on datasets dominated by diversity or correlation shifts. Moreover, ablation experiments were performed. Furthermore, apart from common image classification benchmarks, experiments were further conducted on object detection tasks in autonomous driving.

### 1) OoD-Bench Results on Distribution Shifted Datasets

Contrast experiments were conducted according to the settings of OoD-Bench (Ye et al. 2021). Specifically, PACS (Li et al., 2017), OfficeHome (Venkateswara et al., 2017), TerraIncognita (Beery, Horn, and Perona 2018), and Camelyon17-WILDS (Koh et al. 2020) were selected as benchmark datasets for diversity shift, and modified versions of Colored MNIST (Arjovsky et al., 2019), NICO (He, Shen, and Cui, 2020), and CelebA (Liu et al., 2015) were utilized for benchmarking correlation shift datasets. All experiments, except the Colored MNIST dataset, employed the ResNet-18 model. For the Colored MNIST dataset, a multi-layer perceptor was used. For hyperparameter search, 20 iterations were run for each algorithm and the search process was repeated 3 times. The experiments verified the mean value and standard deviation of the accuracy. For each dataset-algorithm pair, a corresponding ranking score of −1, 0, or +1 is assigned based on the standard error bars which indicate whether the accuracy obtained on the same dataset is lower than, equal to, or higher than the accuracy of ERM, respectively. Eighteen robust OoD generalization algorithms were compared, including Invariant Risk Minimization (IRM, VREx), Distributionally Robust Optimization (DRO), Domain Generalization Methods (MLDG, ERDG), etc. Results on diversity shift-dominated datasets are available in Table 1, while results on correlation shift-dominated datasets are available in Table 2. The scores in Tables 1 and 2 represent how many datasets on which the candidate algorithms outperformed the ERM, and the sum of scores across all datasets yielded the ranking scores for each algorithm.

Tables 1 and 2 reveal that apart from the present application (labeled as SDL), all other methods only outperformed ERM on a particular type of distribution shift, while the present application outperforms ERM on any type.

Specifically, it can be observed from Table 1 that the SDL method proposed in the present application attains the best performance. Existing solutions RSC, MMD, and SagNet outperform the standard Empirical Risk Minimization (ERM) method. This indicates that only a few methods can achieve better performance than ERM through systematic evaluations, unveiling the inherent challenges of OoD generalization. Table 2 reveals that the SDL method remains the top-performing method among all candidate methods, that is, the OoD generalization algorithm provided in the present application can achieve better performance simultaneously on diversity and correlation shift-dominated datasets than ERM. For overall performance, the proposed SDL received a +5 ranking score, followed by RSC and MMD with a ranking score of +1, which means that SDL consistently achieved better performance on most OoD datasets in OoD-Bench.

TABLE 1
Performance of ERM and OoD Generalization Algorithms on Diversity Shift-Dominated Datasets

| Algorithm | PACS | OfficeHome | Terra Incognita | Camelyon17 | Average | Ranking score |
|---|---|---|---|---|---|---|
| SDL(Proposed) | 84.8 ± 0.6 | 63.9 ± 0.1 | 44.1 ± 1.1 | 95.4 ± 0.3 | 72.1 | +4 |
| RSC | 82.8 ± 0.4 | 62.9 ± 0.4 | 43.6 ± 0.5 | 94.9 ± 0.2 | 71.1 | +2 |
| MMD | 81.7 ± 0.2 | 63.8 ± 0.1 | 38.3 ± 0.4 | 94.9 ± 0.4 | 69.7 | +2 |
| SagNet | 81.6 ± 0.4 | 62.7 ± 0.4 | 42.3 ± 0.7 | 95.0 ± 0.2 | 70.4 | +1 |
| ERM (Vapnik 1998) | 81.5 ± 0.0 | 63.3 ± 0.2 | 42.6 ± 0.9 | 94.7 ± 0.1 | 70.5 | 0 |
| IGA | 80.9 ± 0.4 | 63.6 ± 0.2 | 41.3 ± 0.8 | 95.1 ± 0.1 | 70.2 | 0 |
| CORAL | 81.6 ± 0.6 | 63.8 ± 0.3 | 38.3 ± 0.7 | 94.2 ± 0.3 | 69.5 | 0 |
| IRM | 81.1 ± 0.3 | 63.0 ± 0.2 | 42.0 ± 1.8 | 95.0 ± 0.4 | 70.3 | −1 |
| VREx | 81.8 ± 0.1 | 63.5 ± 0.1 | 40.7 ± 0.7 | 94.1 ± 0.3 | 70.0 | −1 |
| GroupDRO | 80.4 ± 0.3 | 63.2 ± 0.2 | 36.8 ± 1.1 | 95.2 ± 0.2 | 68.9 | −1 |
| ERDG | 80.5 ± 0.5 | 63.0 ± 0.4 | 41.3 ± 1.2 | 95.5 ± 0.2 | 70.1 | −2 |
| DANN | 81.1 ± 0.4 | 62.9 ± 0.6 | 39.5 ± 0.2 | 94.9 ± 0.0 | 69.6 | −2 |
| MTL | 81.2 ± 0.4 | 62.9 ± 0.2 | 38.9 ± 0.6 | 95.0 ± 0.1 | 69.5 | −2 |
| Mixup | 79.8 ± 0.6 | 63.3 ± 0.5 | 39.8 ± 0.3 | 94.6 ± 0.3 | 69.4 | −2 |
| ANDMask | 79.5 ± 0.0 | 62.0 ± 0.3 | 39.8 ± 1.4 | 95.3 ± 0.1 | 69.2 | −2 |
| ARM | 81.0 ± 0.4 | 63.2 ± 0.2 | 39.4 ± 0.7 | 93.5 ± 0.6 | 69.2 | −3 |
| MLDG | 73.0 ± 0.4 | 52.4 ± 0.2 | 27.4 ± 2.0 | 91.2 ± 0.4 | 61.0 | −4 |
| Average | 80.8 | 62.6 | 39.8 | 94.6 | 69.4 | — |

TABLE 2
Performance of ERM and OoD Generalization Algorithms on Correlation Shift-Dominated Datasets

| Algorithm | Colored MNIST | CelebA | NICO | Average | Ranking score |
|---|---|---|---|---|---|
| SDL (Proposed) | 58.8 ± 2.2 | 88.6 ± 0.5 | 71.7 ± 0.6 | 73.0 | +2 |
| VREx (Krueger et al. 2020) | 56.3 ± 1.9 | 87.3 ± 0.2 | 71.5 ± 2.3 | 71.7 | +1 |
| GroupDRO (Sagawa” et al. 2020) | 32.5 ± 0.2 | 87.5 ± 1.1 | 71.0 ± 0.4 | 63.7 | +1 |
| ERM (Vapnik 1998) | 29.9 ± 0.9 | 87.2 ± 0.6 | 72.1 ± 1.6 | 63.1 | 0 |
| IRM (Arjovsky et al. 2019) | 60.2 ± 2.4 | 85.4 ± 1.2 | 73.3 ± 2.1 | 73.0 | 0 |
| MTL (Blanchard et al. 2017) | 29.3 ± 0.1 | 87.0 ± 0.7 | 70.6 ± 0.8 | 62.3 | 0 |
| ERDG (Zhao et al. 2020) | 31.6 ± 1.3 | 84.5 ± 0.2 | 72.7 ± 1.9 | 62.9 | 0 |
| ARM (Zhang et al. 2020b) | 34.6 ± 1.8 | 86.6 ± 0.7 | 67.3 ± 0.2 | 62.8 | 0 |
| MMD (Li et al. 2018b) | 50.7 ± 0.1 | 86.0 ± 0.5 | 68.9 ± 1.2 | 68.5 | −1 |
| RSC (Huang et al. 2020) | 28.6 ± 1.5 | 85.9 ± 0.2 | 74.3 ± 1.9 | 62.9 | −1 |
| IGA (Koyama and Yamaguchi 2020a) | 29.7 ± 0.5 | 86.2 ± 0.7 | 71.0 ± 0.1 | 62.3 | −1 |
| CORAL (Sun and Saenko 2016) | 30.0 ± 0.5 | 86.3 ± 0.5 | 70.8 ± 1.0 | 62.4 | −1 |
| Mixup (Yan et al. 2020) | 27.6 ± 1.8 | 87.5 ± 0.5 | 72.5 ± 1.5 | 62.5 | −1 |
| MLDG (Li et al. 2018a) | 32.7 ± 1.1 | 85.4 ± 1.3 | 66.6 ± 2.4 | 61.6 | −1 |
| SagNet (Nam et al. 2019) | 30.5 ± 0.7 | 85.8 ± 1.4 | 69.8 ± 0.7 | 62.0 | −2 |
| ANDMask (Parascandolo et al. 2021) | 27.2 ± 1.4 | 86.2 ± 0.2 | 71.2 ± 0.8 | 61.5 | −2 |
| DANN (Ganin et al. 2016) | 24.5 ± 0.8 | 86.0 ± 0.4 | 69.4 ± 1.7 | 60.0 | −3 |
| Average | 36.2 | 86.4 | 70.9 | 64.5 | — |

### 2) Certified Accuracy for OoD Datasets and Ablation Studies

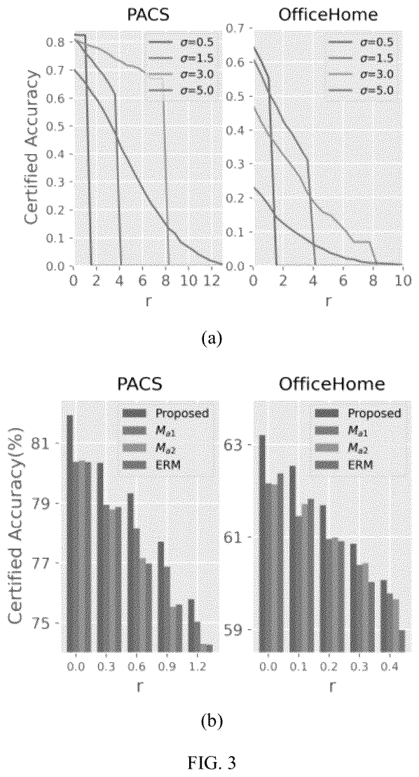

Certified precision is defined as the score of test set samples proven accurate within the maximum permissible generalization set [symbol] . The certified precision of the present application is demonstrated by using PACS and OfficeHome as examples. Referring to FIG. 3, FIG. 3(a) illustrates the relationship between the certified precision of the proposed SDL method and the variance of radius change σ of [symbol] . The line plot shows the certified precision under SDL with different σ of π(η), with the x-axis representing the radius of the generalizable set [symbol] . It can be observed from FIG. 3(a) that varying variances σ can generate different trade-offs between certified precision and the radius of the generalizable set [symbol] . Larger variances typically lead to higher certification precision, in which semantic information deviates further. This aligns well with theoretical analysis, where larger variances lead to larger permissible radii (Formula (7)).

Next, the effectiveness of maximum margin training and stochastic noise was explored for ablation studies. A comparison was made between SDL and variants thereof without max-margin training (Ma1), without stochastic noise (Ma2), or neither (ERM), as shown in FIG. 3(b). It can be observed from FIG. 3(b) that SDL achieves better statistically significant results than its variants at all radius selections. Furthermore, when the deviation increases, the certification precision decreases more noticeably after removing stochastic noise, confirming the necessity of algorithmic components.

The relationship between the radius of [symbol] and variance σ has been theoretically and empirically analyzed, as shown in Formula (7) and FIG. 3(a). The degree of domain shift between training data and test data affects [symbol] through f_{π}_{₀}(z). For datasets with a significant degree of distribution shift, the baseline may struggle to learn f_{π}_{₀}(z) effectively, potentially nearing the 0.5 classification bound. According to ablation studies, this issue has been addressed by highly effective maximum margin training. In fact, based on experimental results, a substantial domain shift does not inherently lead to a very small or disappearing [symbol] -set. For example, for datasets with a significant diversity shift, such as PACS (approximately 0.8 in OoD-Bench), SDL (σ=3.0) certification test precision starts to decline significantly until the radius reaches 8.

3) Visualization of Samples with Certifiable Predictions

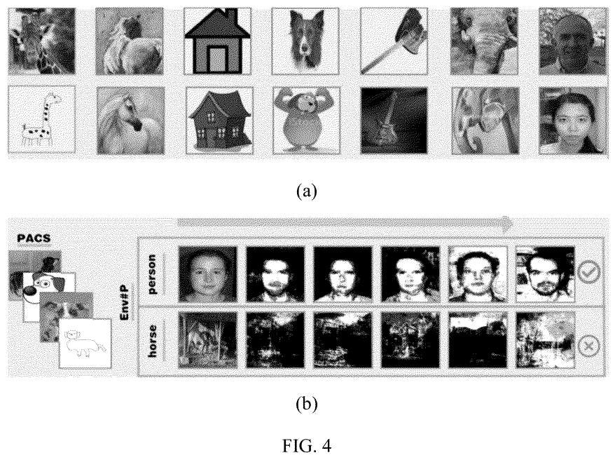

For further analysis, samples proven accurate were visualized, with results shown in FIG. 4. These samples were validated by the certification algorithms, which are semantically similar but drastically different in the pixel space. FIG. 4(a) shows samples with certified predictions, which, despite significant differences in pixel space (e.g., a giraffe in a photographic style versus a giraffe in a sketch style), exhibit semantic similarity and can be reliably categorized as giraffes. Similar observations were made for other categories like horses, houses, dogs, etc. This indicates that the proposed SDL algorithm can be generalized to data with distribution shifts. For a better understanding of why the proposed algorithm is effective, FIG. 4(b) shows visualized samples generated from semantic space during stochastic distribution training. This can be achieved by using a multi-layer perceptor with three layers, which is trained for the task of reconstructing input data based on a given latent semantic representation z. FIG. 4 indicates that samples within the predicted radius through theoretical analysis typically retain the necessary causal information required for predictions, and vice versa. For example, the generated variants of the human figures in the first row maintain semantic similarity to the original images but exhibit different styles such as different genders and hairstyles. Variants generated in the second row, lying outside the certified semantic space, lose the essential information of “horse”. This indicates that, with the present application, the derived certified semantic space correctly reflects the fundamental causal information for classification, as also shown in FIG. 2.

In summary, the present application proposes a certifiable out-of-distribution (OoD) generalization method with theoretical verification, which provides a certifiable OoD generalization performance guarantee through a functional optimization framework. The framework leverages stochastic distributions and maximum margin learning of each input data, providing validated accuracy for predictions in the semantic space of each input. The framework demonstrates better performance simultaneously on OoD datasets dominated by either correlation shifts or diversity shifts, or both. For the first time, it offers statistically better performance on datasets exhibiting two types of distribution shifts compared to ERM. The present application theoretically assures exceptional and consistent performance. Furthermore, the effectiveness of the present application has also been observed in complex real-world tasks such as object detection. The present application demonstrates its potential for future applications in life-critical tasks, including autonomous driving or medical image processing. Among these, a particularly promising domain is simulation computing, such as memristor computing, which can enhance the model generalization performance.

Corresponding to the provided certifiable OoD generalization method, the present application further provides a certifiable OoD generalization system for implementing one or more aspects of the aforementioned method. For example, the system comprises a model fitting module for approximating a deep neural network model using kernelized linear regression; a perturbation learning module for subjecting the deep neural network model to stochastic perturbation learning to derive a classifier for sample separation; a generalization set acquisition module for determining a generalization set of the deep neural network model, wherein the deep neural network model can output accurate predictions when the perturbation range of semantic information lies within the generalization set, the semantic information being defined as the representation of cascaded intermediate layers of the deep neural network model.

It should be noted that the division of various modules in the aforementioned system is merely a division of logic functions. In actual implementation, they can be entirely or partially integrated into a physical entity or physically separated. These modules can be implemented entirely as software called by processing elements, entirely as hardware, or partially as software called by processing elements and partially as hardware. For example, a module may be a standalone processing element or integrated into a chip within an electronic device. Furthermore, it may be stored in the memory of the aforementioned electronic device in the form of program code, called and run by a processing element of the terminal. Other modules are implemented in a similar manner. Furthermore, these modules, either entirely or partially, can be integrated together or independently implemented. The processing element mentioned here may be an integrated circuit with signal processing capabilities. During the implementation, the various modules may be implemented through integrated logic circuits in the hardware of processing elements or in the form of software instructions.

For example, these modules may be configured as one or more integrated circuits for implementing the above method, such as one or more Application Specific Integrated Circuits (ASICs), one or more Digital Signal Processors (DSPs), or one or more Field Programmable Gate Arrays (FPGAs), among others. For another example, when one of the above modules is implemented in the form of program code scheduled by a processing element, that processing element may be a general-purpose processor, such as a Central Processing Unit (CPU), or any other processor capable of calling program code. For another example, these modules may be integrated together in the form of a System-on-a-Chip (SoC).

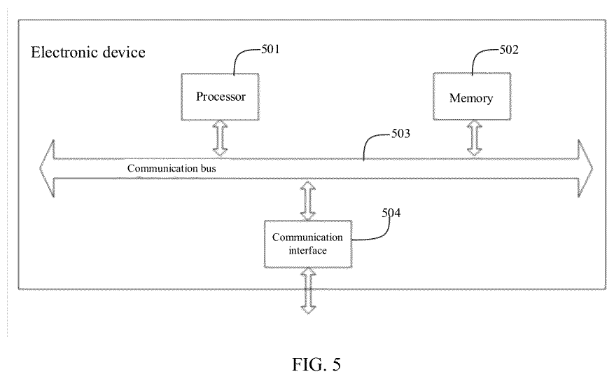

Corresponding to the provided certifiable OoD generalization method, the present application further provides an electronic device. As the embodiments of the electronic device are similar to those of the above method, only a brief description will be provided here. For relevant aspects, please refer to the explanation in the section of the above method embodiments. The electronic device described below is only illustrative. As shown in FIG. 5, the provided electronic device may comprise a processor 501, a memory 502, and a communication bus 503, wherein the processor 501 and the memory 502 communicate via the communication bus 503, and communicate externally through the communication interface 504. The processor 501 can invoke logic instructions stored in the memory 502 to perform the certifiable OoD generalization method, which comprises: approximating a deep neural network model using kernelized linear regression; subjecting the deep neural network model to stochastic perturbation learning to derive a classifier for sample separation; determining a generalization set of the deep neural network model, wherein the deep neural network model can output accurate predictions when the perturbation range of semantic information lies within the generalization set, the semantic information being defined as the representation of cascaded intermediate layers of the deep neural network model.

Furthermore, the logic instructions within the memory 502 can be implemented in the form of software functional units and can be stored in a computer-readable storage medium when marketed or used as a standalone product. Based on such understanding, the technical solutions of the present application essentially, or the part contributing to the prior art, or part of the technical solutions can be embodied in the form of a software product. This computer software product is stored in a storage medium and comprises several instructions for enabling a computer device (such as a personal computer, a server, or a network device) to execute all or some steps of the methods described in various embodiments of the present application. The aforementioned storage medium comprises a storage chip, a USB drive, a removable hard disk, a Read-Only Memory (ROM), a Random Access Memory (RAM), a magnetic disk, or an optical disk, among various media capable of storing program code.

In another aspect, embodiments of the present application further provide a computer program product, which comprises a computer program stored on a processor-readable storage medium. The computer program comprises program instructions that, when executed by a computer, enable the computer to perform the certifiable OoD generalization method provided in the various method embodiments mentioned above. The method comprises: approximating a deep neural network model using kernelized linear regression; subjecting the deep neural network model to stochastic perturbation learning to derive a classifier for sample separation; determining a generalization set of the deep neural network model, wherein the deep neural network model can output accurate predictions when the perturbation range of semantic information lies within the generalization set, the semantic information being defined as the representation of cascaded intermediate layers of the deep neural network model.

In yet another aspect, embodiments of the present application further provide a processor-readable storage medium, which has a computer program stored thereon. The computer program, when run by the processor, implement the certifiable OoD generalization method provided in the various embodiments mentioned above. The method comprises: approximating a deep neural network model using kernelized linear regression; subjecting the deep neural network model to stochastic perturbation learning to derive a classifier for sample separation; determining a generalization set of the deep neural network model, wherein the deep neural network model can output accurate predictions when the perturbation range of semantic information lies within the generalization set, the semantic information being defined as the representation of cascaded intermediate layers of the deep neural network model.

The processor-readable storage medium may be any available medium or data storage device accessible by the processor, including but not limited to magnetic memory (e.g., floppy disks, hard disks, magnetic tapes, magnetic-optical disks (MO), etc.), optical memory (e.g., CDs, DVDs, BDs, HVDs, etc.), and semiconductor memory (e.g., ROM, EPROM, EEPROM, NAND FLASH, solid-state disks (SSD)), etc.

The described embodiments of the apparatus are purely illustrative. The units described as separate components may or may not be physically separate, and the components displayed as units may or may not be physical units, meaning they could be located in one place or distributed across multiple network units. Some or all of the modules can be selected according to the actual needs to achieve the objectives of the embodiments. Those of ordinary skill in the art can understand and implement without inventive effort.

Through the description of the above embodiments, those skilled in the art can clearly understand that various embodiments can be implemented using software along with necessary general-purpose hardware platforms, or alternatively, through hardware means. Based on such understanding, the technical solutions essentially or the part contributing to the prior art can be embodied in the form of a software product. This computer software product can be stored in a computer-readable storage medium, such as a ROM/RAM, a magnetic disk, and an optical disk, and comprises several instructions for enabling a computer device (such as a personal computer, a server, or a network device) to execute the method according to the various embodiments or some parts of the embodiments.

Lastly, it should be noted that the computer-readable program instructions may also be loaded onto a computer, other programmable data processing apparatus, or other devices to cause a series of operational steps to be executed on the computer, other programmable apparatus or other devices to produce a computer implemented process such that the instructions executed on the computer, other programmable data processing apparatus or other devices implement the functions/motions specified in the one or more blocks of the flowchart and/or block diagrams.

The flowchart and block diagrams in the figures illustrate the architecture, functions, and operation of possible implementations of the system, method and computer program product according to various embodiments of the present application. In this regard, each block in the flowchart or block diagrams may represent a portion of a module, segment or instructions which comprises one or more executable instructions for implementing the specified logical functions. In some alternative implementations, the functions noted in the blocks may occur out of the order noted in the figures. For example, two blocks shown in succession may, in fact, be executed substantially concurrently, or the blocks may sometimes be executed in the reverse order, depending upon the functions involved. It should also be noted that each block in the block diagrams and/or the flowchart, and combinations of blocks in the block diagrams and/or the flowchart, can be implemented by special-purpose hardware-based systems that perform the specified functions or motions, or by combinations of special-purpose hardware and computer instructions. For those skilled in the art, it is well-known that achieving implementation through hardware, software, or a combination of both is considered equivalent.

While various embodiments of the present application have been described above, the descriptions are exemplary, not exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the practical application or technical improvements in the market, or to enable others of ordinary skill in the art to understand the embodiments disclosed herein. The scope of the present application is defined by the appended claims.

What is claimed is:

1. A certifiable out-of-distribution (OoD) generalization method, comprising the following steps:
approximating a deep neural network model using kernelized linear regression;
subjecting the deep neural network model to stochastic perturbation learning to derive a classifier for sample separation; and
determining a generalization set of the deep neural network model, wherein the deep neural network model can output accurate predictions when a perturbation range of semantic information lies within the generalization set, the semantic information being defined as a representation outputted by cascaded intermediate layers of the deep neural network model.

2. The certifiable OoD generalization method according to claim 1, wherein in the process of subjecting the deep neural network model to stochastic perturbation learning, an expected stochastic perturbation loss for a data pair (Xⁱ, Yⁱ) is set as:
$$[ ℓ ( f ( {X}^{i} ; θ ) , {Y}^{i} ) ] = {( 0 , {σ}^{2} )}_{} [ ℓ ( {f}_{L - 1} ( ( z + η ) ; θ ) , {Y}^{i} ) ]$$
where z denotes an intermediate representation learned by the deep neural network model, z=f_{L-2}∘ . . . ∘f₀(Xⁱ; θ), σ represents a variance of a Gaussian distribution, f(⋅; θ)=f_{L-1} ∘ f_{L-2} . . . ∘f₀ represents an L-layer deep neural network model, θ represents a parameter of the deep neural network model, π₀ represents stochastic perturbation distribution, [symbol] represents a loss function, and η represents stochastic disturbance conforming to the Gaussian distribution.

3. The certifiable OoD generalization method according to claim 1, wherein employing maximum margin training to perform stochastic perturbation learning on the deep neural network model, with an optimization objective on the training set as:
$${min}_{w} \frac{1}{2} {‖ w ‖}^{2} + C {\sum }_{i = 1}^{n} max ( 0 , \underbrace{1 - {y}_{i} ( {f}_{{π}_{0}} ( {x}_{i} ; {w}_{0} ) + {Ψ}_{{π}_{0}} ( {x}_{i} ; {w}_{0} ) ( w - {w}_{0} ) )}_{Training loss} )$$
where Ψ_{π}_{₀}(x; w₀) represents neural tangent kernel, C represents a hyperparameter, Xᵢ and yᵢ represent an i-th input data pair, n represents a number of input data pairs, Training loss represents a training loss, w represents a parameter of a last layer of the deep neural network model, w₀ represents an initialization of the last layer of the deep neural network model, π₀ represents stochastic perturbation distribution, and f_{π}_{₀} denotes the deep neural network model under stochastic perturbation.

4. The certifiable OoD generalization method according to claim 3, wherein the generalization set of the deep neural network model is determined according to the following steps:
solving the following problem:
$$ℒ = {min}_{f ∈} {min}_{δ ∈} {max}_{λ ∈} \{ {\hat{f}}_{{π}_{0}} ( z ⊗ δ ) - λ ( {\hat{f}}_{{π}_{0}} ( z ) - {f}_{{π}_{0}} ( z ) ) \} \geq {max}_{λ \geq 0} \{ λ {f}_{{π}_{0}} ( z ) - {max}_{δ ∈ B} {𝔻}_{ℱ} ( {λπ}_{0} , {π}_{δ} ) \}$$
determining generalization set [symbol] by solving [symbol] >½;
where:
$$= {max}_{f ∈} \{ {λ𝔼}_{η [ {π}_{0}} [ \hat{f} ( z ⊗ η ) ] - {η ∼ {π}_{δ}}_{} [ \hat{f} ( z ⊗ η ) ] \} = \{ \begin{matrix}\int {[ {λπ}_{0} ( η ) - {π}_{δ} ( η ) ]}_{+} d η , if π is continuous \\ {Σ [ {λπ}_{0} ( η ) - {π}_{δ} ( η ) ]}_{+} , if π is discrete\end{matrix} ;$$
where η represents stochastic disturbance, f represents a deep neural network model, and f is relaxed to the functional space [symbol] ={\hat{f}:\hat{f}(z)∈[0,1], ∀z∈ [symbol] }, δ represents variation with respect to z.

5. The certifiable OoD generalization method according to claim 4, wherein when input representations of the deep neural network model satisfies a Gaussian distribution, the generalization set of the deep neural network model is determined according to the following steps:
instantiating π₀ as a Gaussian distribution centered at 0: [symbol] (0, σ²I), with a perturbation range r satisfying a lower bound of prediction confidence:
$$ℒ \geq Φ ( {Φ}^{- 1} ( {f}_{{π}_{0}} ( z ) ) - \frac{r}{σ} ) > 12$$
where Φ( ) represents a cumulative density function of a standard Gaussian distribution, given by:
$$r < {σΦ}^{- 1} ( {f}_{{π}_{0}} ( z ) )$$
where f_{π}_{₀}(z):= [symbol] _{η˜π}_{₀}[f(z⊗η)], σ represents the variance of the Gaussian distribution.

6. The certifiable OoD generalization method according to claim 1, wherein when input representations of the deep neural network model satisfies a Bernoulli distribution, the generalization set of the deep neural network model is determined according to the following steps:
instantiating π₀ as a Bernoulli distribution, with a perturbation range r satisfying a lower bound of prediction confidence:
$$ℒ \geq max \{ {f}_{{π}_{0}} ( z ) - 1 + {p}^{r} , 0 \} > \frac{1}{2}$$
where:
$$r < \frac{ln ( 1.5 < {f}_{{π}_{0}} ( z ) )}{ln p}$$
where p represents a parameter of the Bernoulli distribution, p∈[0,1), and r represents a perturbation range.

7. The certifiable OoD generalization method according to claim 1, wherein the deep neural network model is a binary classification model, and the generalization set is defined as:
for any perturbation δ in the generalization set [symbol] , f(z⊗δ)>½, where f(z)∈[0,1], z denotes an intermediate representation learned by the deep neural network model, and f(⋅) represents a deep neural network model.

8. The certifiable OoD generalization method according to claim 1, further comprising computing certified precision based on the determined generalization set, wherein the certified precision is a score of test set samples proven accurate within the generalization set.

9. A non-transitory computer-readable storage medium having a computer program stored thereon, wherein the computer program, when run by a processor, implements the steps of the method according to claim 1.

10. A computer device, comprising a memory and a processor, wherein a computer program capable of running on the processor is stored on the memory, and the processor runs the computer program to implement the steps of the method according to claim 1.
